(19) United States
(12) Patent Application Publication
(10) Pub. No.: US 2007/0091474 A1
(43) Pub. Date: Apr. 26, 2007

(54) Apparatus for enhancing use of optical devices

(76) Inventor: Ronald Lee Hubbard, Belton, TX (US)

Correspondence Address: Michael J. D'Amelio, 1051 Great Oaks Drive, Salado, TX, 76571, US

(21) Appl. No.: 11/255,331

(22) Filed: Oct. 21, 2005

(51) Int. Cl. G02B 7/02

(52) U.S. Cl. 359/808

(57) ABSTRACT

Disclosed is an apparatus for protecting the outer lenses of optical devices, such as binoculars, telescopes, and various types of cameras, from the elements, primarily in extreme outdoor conditions. More specifically, the disclosed invention relates to a specialized flexible visor for such an optical device. In application, the present invention prevents elements such as rain and sun glare from interfering with use of these types of optical devices.

### FIELD OF THE INVENTION

The disclosed invention relates to an apparatus for protecting the outer lenses of various types of optical devices, such as binoculars, telescopes, video cameras, still-photography cameras, and the like, from the elements in extreme outdoor conditions. More specifically, the disclosed invention relates to a specialized flexible visor for such devices, which when applied to these devices prevents elements such as rain and sun glare from interfering with their use.

### BACKGROUND

Various methods and apparatus for protecting optical devices from the elements are shown in the prior art. Such prior art is typically designed to reduce interference by sun glare, rain, and the like with use of such optical devices. Consider, for example, that hunters use binoculars while participating in the sport of hunting. Glare from the sun can substantially interfere with a hunter's effective use of binoculars, thus detracting not only from the vision enhancing purpose of the binoculars but also detracting from the overall enjoyment of the sport. A device that effectively prevents sun glare, rain, and the like from interfering with use of binoculars during hunting may be quite valuable to a hunter in enhancing the overall recreational experience.

Consider also, for example, that photographers use cameras with various types of lenses while engaging in outdoor photography. Glare from the sun can substantially interfere with a photographer's effective use of a camera, thus detracting not only from the quality of images taken with the camera but also detracting from the overall enjoyment and income producing potential of the endeavor. A device that effectively prevents sun glare, rain, and the like from interfering with use of a camera during outdoor photography sessions may be quite valuable to a photographer in enhancing the overall photography experience, the quality of images taken, and the resulting income potential of any such endeavor.

Prior art devices all fall short to some degree of solving the overall problem of optical device protection. Some prevent sun glare from above, but do not prevent sun glare from the sides. Others are bulky and cumbersome to fit onto a given optical device. Still others are relatively complicated and expensive to produce. Others prevent certain environmental interference with use of an optical device, but then cause a resulting interference of their own by detrimentally effecting the user's field of vision.

Consider, for example, U.S. Pat. No. 6,450,651 to Hoganson which discloses an anti-glare device for objective lenses. The Hoganson device substantially comprises a cylinder that fits snugly around an objective lense on an optical device. The problem with the Hoganson device is that it can, itself, cause limitations to the user's field of vision because of its close proximity to the field of light input to the objective lense during use. Also, a separate Hoganson device is necessary for each objective lense present, and therefore, for example, two devices would be necessary for use on a pair of binoculars.

Consider also, for example, U.S. Pat. No. 4,927,017 to Easter which discloses a protective cover for a video camera. The Easter device includes a visor which extends outwardly over the lense of the video camera, and in such a way that the visor, itself, may interfere with the field of view. Also, this device includes a bulky camera cover and a plurality of fasteners. In other words, this device is relatively complicated to manufacture and install on a video camera, and presents an unnecessary encumbrance particularly if it were to be used on other types of optical devices such as telescopes, binoculars, still-photography cameras, and the like.

Therefore, there exists a need for a device that protects optical devices from environmental factors such as sun glare, rain, and the like that is simple and inexpensive to manufacture, simple and effective to use, and that can be used effectively with a plurality of different types of optical devices. There also exists a need for such a device that does not itself cause interference with the user's field of vision through the optical device or otherwise cause detrimental effects of any kind to use of such optical devices. The present invention achieves all of these needs.

### SUMMARY OF THE INVENTION

The following and other objects of the present invention will become apparent from a review of the drawings and the following description of the preferred embodiments.

Disclosed is an apparatus for enhancing use of an optical device, such as a pair of binoculars, in extreme environments, and in particular to prevent rain, sun glare, and the like from interfering with use of such devices. Such devices may include binoculars, telescopes, video cameras, still-photography cameras, and the like. The apparatus substantially takes the form of a visor which when applied to such a device extends outwardly over and past the outer lenses thus shielding the outer lenses from interference by the elements. This prevents such elements as rain and sun glare from interfering with the user's vision. Also, the visor is configured so as to flare outwardly from the outer lenses to prevent or minimize any interference the visor itself may cause with the user's field of vision or use of these devices.

The optical devices are described herein as having top, bottom, and opposing side portions. These devices further have a proximal end and a distal end, the distal end including the outer lenses. The body portion of the visor is a substantially flexible, substantially trapezoid-shaped member, having a proximal edge substantially parallel to a distal edge, and first and second opposing side edges, the distal edge being longer than the proximal edge. Both the distal edge and the proximal edge may be slightly arcuate so as to prompt the visor to flare outwardly away from the outer lenses when the visor is applied to the binoculars, thereby minimizing visor interference with the user's field of vision or other use of the device.

Included on the visor is a substantially flexible attachment member having a fixed end and a free end, the fixed end being fixed to the body portion at the first side edge. Engagement means are fixed to the body portion at the second side edge, and are capable of engagement with the free end of the flexible attachment member so as to secure the apparatus to the optical device.

The body portion of the visor comprises a material having sufficient flexibility to wrap substantially about at least the top and side portions of the optical device.

The distal edge of the body portion overhangs the distal end of the optical device when the apparatus is applied to the optical device to protect the outer lenses from environmental factors such as rain and sun glare. The body portion also comprises a material having sufficient rigidity so as to cause the distal edge of the body portion to flare outwardly from the top and side portions of the device when the visor is in use, and to remain in such position without sagging or otherwise falling inward toward the lenses.

The free end of the attachment member and the engagement means both may comprise a Velcro fastener system. As an alternative, the free end of the attachment member and the engagement means both may comprise a strap and buckle fastener system.

### BRIEF DESCRIPTION OF THE DRAWINGS

FIG. 1A depicts the present invention in plan view and unapplied to an optical device.

FIG. 2 depicts the present invention in side view and as applied to a double or single lense optical device, shown in phantom.

FIG. 3 depicts the present invention in front view and as applied to a double lense optical device, shown in phantom.

FIG. 4 depicts the present invention in front view and as applied to a single lense optical device, shown in phantom.

### DETAILED DESCRIPTION OF THE PREFERRED EMBODIMENTS

The present invention is a protective apparatus for optical devices such as binoculars, still-photography cameras, telescopes, video cameras and the like. The invention protects lenses of such devices from elements such as sun glare, rain, dust, and anything else that would interfere with a user's enjoyment and use of these types of devices.

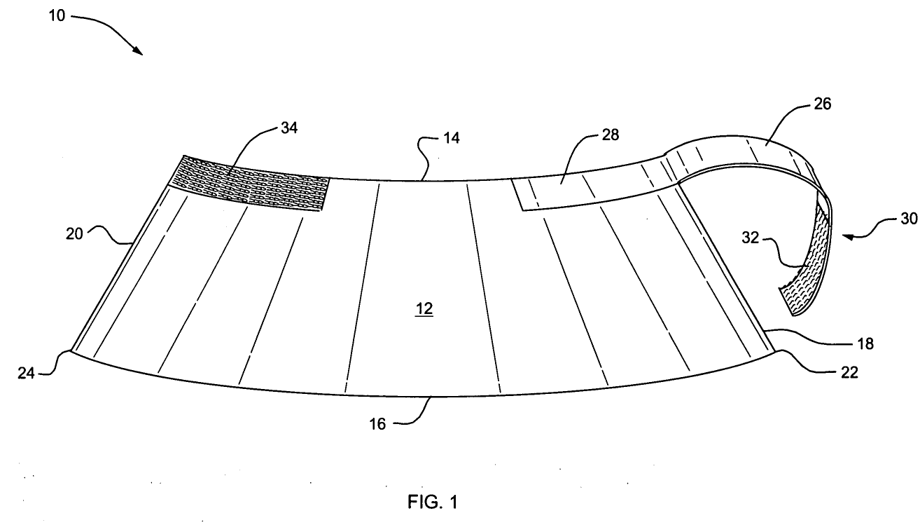

Referring now to FIG. 1, the present invention may consist of a visor 10, further including a body portion 12. Body portion 12 is a relatively thin flat piece of material or laminated composite that is flexible enough to wrap substantially around at least the top and sides of an optical device and rigid enough to extend outwardly past the distal end of such optical device when in use (as will be further explained below).

Body portion 12 may be made of any synthetic or natural material that accomplishes the objectives as stated above. Such materials including but not limited to sheet plastics, sheet rubbers, foamed rubber sheeting, or leather may be used successfully. Also, laminated materials, for example rubber or vinyl sheeting bonded to a semi-rigid plastic layer may be used successfully.

Body portion 12 is configured with a slightly arcuate proximal edge 14 which is substantially parallel to a slightly arcuate distal edge 16. First side edge 18 and second side edge 20 both angle outwardly from proximal edge 14 and inwardly from distal edge 16 so as to form first wing 22 and second wing 24 at the intersections between edges 18 and 20 and distal edge 16. Wings 22 and 24 are particularly useful in preventing environmental interference directed at an optical device from the sides, such as rain and dust carried by winds. The shape of body portion 12 is critical to the proper functioning of visor 10, as will be explained in more detail below.

Attachment of visor 10 to an optical device may be accomplished with a strap 26, which has a fixed end 28 and a free end 30. The strap 26 is ideally fixed to body portion 12 near either the intersection of edge 14 and edge 18 or that of edge 14 and edge 20. Fixed end 28 may be bonded, stitched, stapled, or otherwise fixedly attached to body portion 12. Free end 30 may be provided with a fastening system 32, such as Velcro, on its underside. A cooperating fastening system 34 is fixedly attached to the opposite location along edge 14, as shown in FIG. 1. Strap 26 is of such a length so as to accommodate the size of the optical device in question and so that the cooperating fastening system may be secured around the optical device during use.

The fastening system may also include a buckle and strap type system, or even two strings or straps which may be fixed to body portion 12 along edge 14 in such a way that they may be tied to secure the visor to the optical device. Also, the fastening system may comprise an elastic strap provided with snap-type fasteners, buttons, or buckles, so long as the strap and fastener system is capable of securing visor 10 to an optical device during use.

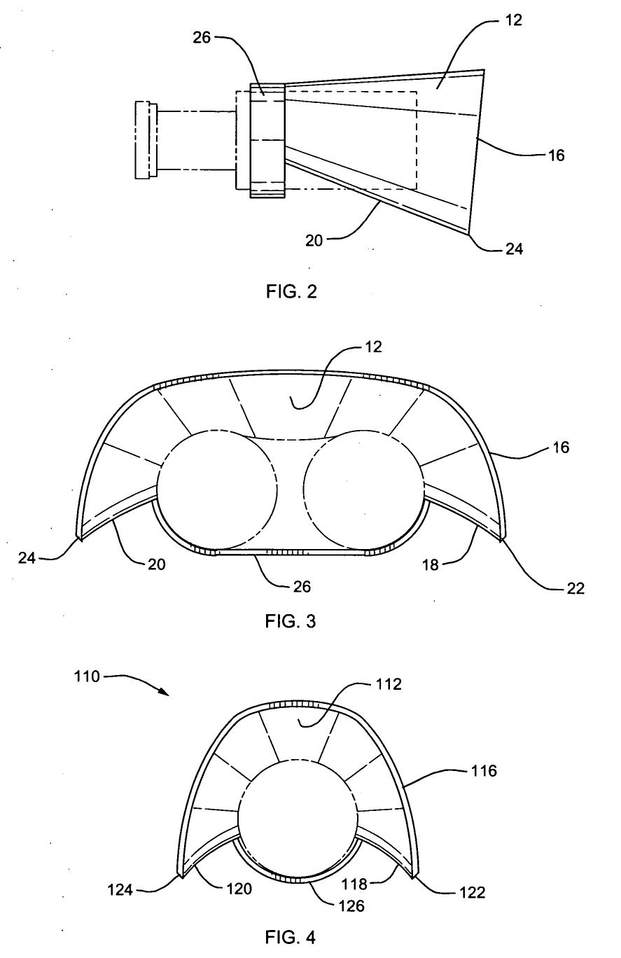

Referring now to FIG. 2, visor 10 is shown as applied to an optical device. The configuration of visor 10 is critical, in that when applied to an optical device visor 10 takes on a slightly conical form. The open end of the cone extending outwardly past the distal end of the optical device results in a flaring outward of visor 10 away from the edges of the outer lenses. This allows visor 10 to accomplish the desired goal of protecting the lenses from environmental effects while at the same time not interfering with the field of vision through the lenses because of close proximity to the lenses.

Referring now to FIGS. 2 and 3 together, during application visor 10 is positioned over the optical device, in this case a pair of binoculars, and as strap 26 is pulled snugly around the device body portion 12 wraps substantially around the top and sides of the device. Visor 10 is positioned so that a substantial portion of its width proximate to distal edge 16 overhangs the distal edge of the optical device for proper functionality. As strap 26 is pulled snugly and cooperating fastening systems 32 and 34 are engaged, the reasoning behind the configuration of body portion 12 becomes clear—it takes on a conical form which causes the distal edge 16 to flare outwardly from the distal end of the optical device to avoid interference with proper use of the device.

Because of the balance of rigidity and flexibility in the material of body portion 12, wings 22 and 24 flare outwardly from the sides of the optical device when in use. This allows added protection from sun glare from the sides, rain and dust carried by wind gusts, and the like.

Referring to FIG. 4, the present invention is shown as applied to a single lense optical device. The method of construction of visor 110 is the same as described above. However, its configuration would be adjusted to accommodate the shorter length of body portion 112 and strap 126 necessary for use on such- a single lense device. The application method, protective qualities, and other aspects, features, and benefits of visor 110 remain the same.

Having thus described exemplary embodiments of the present invention, it should be noted by those skilled in the art that the above disclosures are exemplary only and that various other alternatives, adaptations, and modifications may be made within the scope of the invention. Accordingly, it is to be understood that the present invention is not limited to the precise construction as shown in the drawings and described hereinabove.

I claim:

1. An apparatus for enhancing use of an optical device in extreme environments, the optical device having top, bottom, and opposing side portions, the optical device further having a proximal end and a distal end, the apparatus comprising:
a substantially flexible, substantially trapezoid-shaped body portion, having a proximal edge substantially parallel to a distal edge, and first and second opposing side edges, the distal edge being longer than the proximal edge;
a substantially flexible attachment member having a fixed end and a free end, the fixed end being fixed to the body portion at the first side edge;
engagement means fixed to the body portion at the second side edge, capable of engagement with the free end of the flexible attachment member so as to secure the apparatus to the optical device.

2. The apparatus of claim 1, wherein the optical device is a pair of binoculars, a telescope, a video camera, or a still-photography camera.

3. The apparatus of claim 2, wherein the body portion comprises a material having sufficient flexibility to wrap substantially about at least the top and side portions of the optical device.

4. The apparatus of claim 3, wherein the distal edge of the body portion overhangs the distal end of the optical device when the apparatus is applied to the optical device.

5. The apparatus of claim 4, wherein the body portion comprises a material having sufficient rigidity so as to cause the distal edge of the body portion to flare outwardly from the top and side portions of the optical device when the apparatus is applied to the optical device.

6. The apparatus of claim 5, wherein the free end of the attachment member and the engagement means both comprise a Velcro fastener system.

7. The apparatus of claim 6, wherein the free end of the attachment member and the engagement means both comprise a strap and buckle fastener system.

8. An apparatus for enhancing use of an optical device in extreme environments, the optical device having top, bottom, and opposing side portions, the optical device further having a proximal end and a distal end, the apparatus comprising:
a substantially flexible, substantially trapezoid-shaped body portion, having a slightly arcuate proximal edge substantially parallel to a slightly arcuate distal edge, and first and second opposing side edges, the distal edge being longer than the proximal edge;
a substantially flexible attachment member having a fixed end and a free end, the fixed end being fixed to the body portion at the first side edge substantially along the proximal edge;
engagement means fixed to the body portion at the second side edge substantially along the proximal edge, capable of engagement with the free end of the flexible attachment member so as to secure the apparatus to the optical device.

9. The apparatus of claim 8, wherein the optical device is a pair of binoculars, a telescope, a video camera, or a still-photography camera.

10. The apparatus of claim 9, wherein the body portion comprises a material having sufficient flexibility to wrap substantially about at least the top and side portions of the optical device.

11. The apparatus of claim 10, wherein the distal edge of the body portion overhangs the distal end of the optical device when the apparatus is applied to the optical device.

12. The apparatus of claim 11, wherein the body portion comprises a material having sufficient rigidity so as to cause the distal edge of the body portion to flare outwardly from the top and side portions of the optical device when the apparatus is applied to the optical device.

13. The apparatus of claim 12, wherein the free end of the attachment member and the engagement means both comprise a Velcro fastener system.

14. The apparatus of claim 13, wherein the free end of the attachment member and the engagement means both comprise a strap and buckle fastener system.

15. An apparatus for enhancing use of binoculars in extreme environments, the apparatus substantially comprising a visor for the binoculars, the binoculars having top, bottom, and opposing side portions, the binoculars further having a proximal end and a distal end, the visor further comprising:
a substantially flexible, substantially tiapezoid-shaped body portion, having a slightly arcuate proximal edge substantially parallel to a slightly arcuate distal edge, and first and second opposing side edges, the distal edge being longer than the proximal edge;
the intersections of the distal edge and first and second opposing side edges substantially forming winged portions of the visor;
a substantially flexible attachment strap having a fixed end and a free end, the fixed end being fixed to the body portion proximate to the intersection of the first side edge and the proximal edge; engagement means fixed to the body portion proximate to the intersection of the second side edge and the proximal edge, the engagement means being capable of engagement with the free end of the strap so as to secure the apparatus to the visor.

16. The apparatus of claim 15, wherein the body portion comprises a material having sufficient flexibility to wrap substantially about at least the top and side portions of the binoculars.

17. The apparatus of claim 16, wherein the distal edge of the body portion overhangs the distal end of the binoculars when the visor is applied to the binoculars.

18. The apparatus of claim 17, wherein the body portion comprises a material having sufficient rigidity so as to cause the distal edge of the body portion to flare outwardly from the top and side portions of the binoculars when the visor is applied to the binoculars.

19. The apparatus of claim 18, wherein the free end of the strap and the engagement means both comprise a Velcro fastener system.

20. The apparatus of claim 19, wherein the free end of the strap and the engagement means both comprise a strap and buckle fastener system.
